(19) United States
(12) Patent Application Publication
(10) Pub. No.: US 2012/0116876 A1
(43) Pub. Date: May 10, 2012

(54) APPARATUS AND METHODS FOR PROVIDING TARGETED ADVERTISING FROM USER BEHAVIOR

(75) Inventor: William W. Graham, JR., Mill Valey, CA (US)

(73) Assignee: CBS INTERACTIVE IN., San Francisco, CA (US)

(21) Appl. No.: 12/942,823

(22) Filed: Nov. 9, 2010

(51) Int. Cl. G06Q 30/00

(52) U.S. Cl. 705/14.53

(57) ABSTRACT

Various embodiments for providing advertisements targeted from user behavior are described. In one or more embodiments, an ad optimizing service may collect user behavior events and compare the collected behavior to a set of rules. When behavior matches a rule, the user may be associated with a segment, which may be provided to an advertising service. The advertising service may select an advertisement for the user based on the segment. Other embodiments are described and claimed.

### BACKGROUND

Many web sites serve advertisements along with the content of the web site. Advertisers may pay for ad space based on various contextual criteria, such as page content. However, this context is limited in that it does not take into consideration the behavior of the particular user viewing the page. Different users may arrive at the same web page for different reasons. Accordingly, there may be a need for an improved apparatus and methods for providing targeted advertising from user behavior.

### BRIEF DESCRIPTION OF THE DRAWINGS

FIG. 1 illustrates a system for targeted advertising in accordance with one or more embodiments.

FIG. 2 illustrates an ad optimizing system in accordance with one or more embodiments.

FIG. 3 illustrates a system for targeted advertising in accordance with one or more embodiments.

FIG. 4 illustrates a logic flow in accordance with one or more embodiments.

FIG. 5 illustrates a computing architecture in accordance with one or more embodiments.

### DETAILED DESCRIPTION

Various embodiments are directed to providing advertisement on a web page that is targeted according to the user's online behavior. Embodiments may include an ad optimizing service that collects user behavior events and compares the collected behavior to a set of rules. When behavior matches a rule, the user may be associated with a segment, which may be provided to an advertising service. The advertising service may select an advertisement for the user based on the segment.

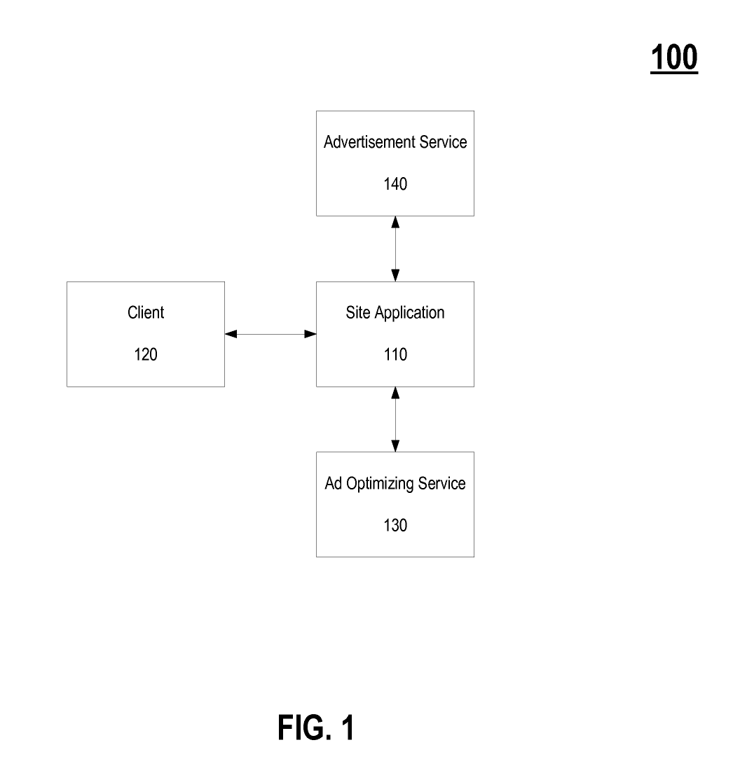

FIG. 1 illustrates a system 100 to provide targeted advertising based on a user's behavior. In one embodiment, for example, the system 100 may comprise a computer-implemented system having multiple components, such as site application 110, client 120, ad optimizing service 130 and advertisement service 140. As used herein the terms “system” and “component” are intended to refer to a computer-related entity, comprising either hardware, a combination of hardware and software, software, or software in execution. For example, a component can be implemented as a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers as desired for a given implementation. The embodiments are not limited in this context.

In the illustrated embodiment shown in FIG. 1, the system 100 may be implemented by one or more electronic devices. Examples of an electronic device may include without limitation a mobile device, a personal digital assistant, a mobile computing device, a smart phone, a cellular telephone, a handset, a one-way pager, a two-way pager, a messaging device, a computer, a personal computer (PC), a desktop computer, a laptop computer, a notebook computer, a handheld computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, television, digital television, set top box, wireless access point, base station, subscriber station, mobile subscriber center, radio network controller, router, hub, gateway, bridge, switch, machine, or combination thereof. Although the system 100 as shown in FIG. 1 has a limited number of elements in a certain topology, it may be appreciated that the system 100 may include more or less elements in alternate topologies as desired for a given implementation.

The components of system 100 may be communicatively coupled via various types of communications media. The components may coordinate operations between each other. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Examples of connections may include parallel interfaces, serial interfaces, and bus interfaces.

In an embodiment, system 100 may include site application 110. Site application 110 may include a web site hosting application or other suitable application for serving content to clients, such as client 120. Client 120 may be a computing device operating a browser or other application suitable for receiving and displaying the content served by site application 110. Site application 110 may invoke ad optimizing service 130 to track user behavior and to receive user segment information. Site application 110 may use the user segment information, via advertisement service 140, to modify the default content served to client 120.

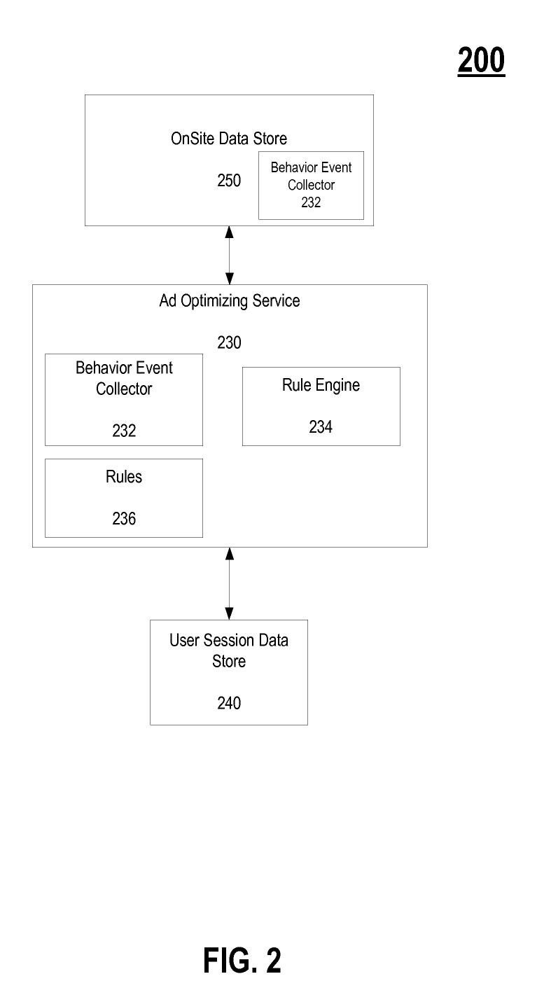

In an embodiment, system 100 may include ad optimizing service 130. Ad optimizing service 130 may collect information about user behavior online, and may compare the collected behavior events against a set of rules in order to classify the user in one or more segments. Ad optimizing service 130 may provide the segment information to site application 110. In an embodiment, ad optimizing service 130 may be a representational state transfer (REST) architecture application program interface (API). Ad optimizing service 130 may be invoked as a REST API by site application 110 or a browser when a user loads a web page. Ad optimizing service 130 is discussed in further detail below with respect to FIG. 2.

In an embodiment, system 100 may include advertisement service 140. Advertisement service 140 may be in communication with site application 110. Advertisement service 140 may receive the segment information from ad optimizing service 130 via site application 110, and may use the segment to select an advertisement to insert into the content served by site application 110 and displayed to client 120. The embodiments are not limited in this context.

FIG. 2 illustrates a block diagram 200 of an embodiment of an ad optimizing service 230. Ad optimizing service 230 may be an embodiment of ad optimizing service 130. Ad optimizing service 230 may include one or more functional components, such as behavior event collector 232 and rule engine 234. Ad optimizing service 230 may further include rules 236.

Behavior event collector 232 may collect user behavior events from a user. Behavior events may include, for example, search strings entered, links followed, files downloaded, previous site visited before the current site, etc. Behavior events may be stored, for example, in user session data store 240. Behavior event collector 232 may collect user behavior events, for example, by examining cookie files on client 120, fetching user behavior events from other APIs, or otherwise examining browser history for a user accessing site application 110. In an embodiment, behavior event collector 232 may use an anonymous unique user ID to distinguish among multiple users. The anonymous unique user ID may be assigned, for example, by site application 110.

Rule engine 234 may compare the collected user behavior events to rules in rules 236 to determine whether a particular action or series of actions has taken place. A rule may be, for example, an XML configuration file, or may reside in a database. A rule may contain one or more conditions that must be met, whereupon the user will be assigned a segment specified by the rule. A rule may specify, for example, if (1) the user came from a search engine, e.g. Google, Yahoo, or Bing; and (2) searched for mountain bikes; then assign the segment “mountain bike enthusiast” to the user. The segment may be provided to site application 110 and passed to advertisement service 140. Advertisement service 140 may then target advertisements that relate to mountain biking. In an embodiment, segment data for a user may also be stored in user data store 240.

In an embodiment, the rules may be configurable, for example, by an individual at site application 110. An individual at site application 110 may also create the segments that are provided to advertisement service 140 for targeting. Different revenue streams may be associated with different segments. A segment may have one or more rules associated with it that, when met, cause the user to be associated with that segment.

In an embodiment, segments may include a name and a unique number or identifier. The unique identifier may be supplied to the advertising service instead of the name, in order to protect proprietary business information that may be contained in the name. In an embodiment, the unique identifier may be generated in a non-sequential manner in order to dissuade hacking attempts to discover the name.

An embodiment may include an onsite data store 250 instead of user session data store 240. In such an embodiment, behavior event collector 232 may reside with, or in communication with, onsite data store 250 instead of with ad optimizing service 230. Onsite data store 250 may then collect the user behavior events and pass the collected data to ad optimizing service 230 for processing with rule engine 234.

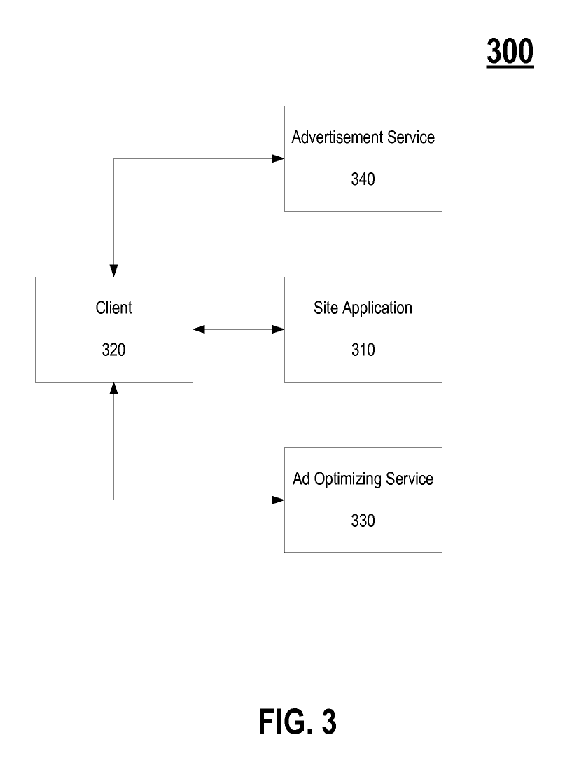

FIG. 3 illustrates a system 300 similar to system 100. In the embodiment shown in FIG. 3, site application 310 is unaware of ad optimizing service 330. Instead, pages served by site application 310 may contain a script that inspects the page and calls ad optimizing service 330 from client 320. Ad optimizing service 330 determines the segment for the user, and returns the segment to client 320, which may pass the segment to advertising service 340.

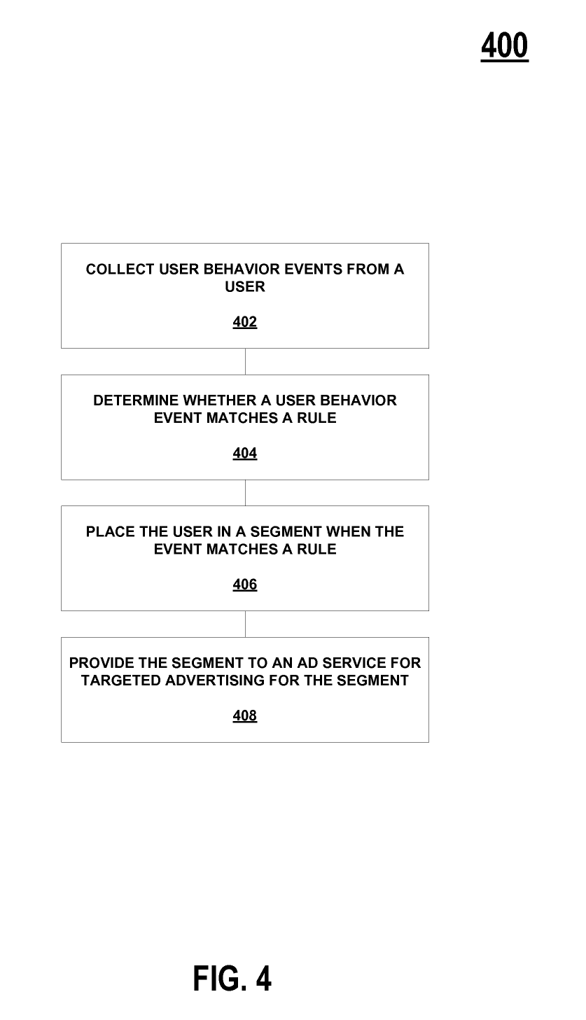

FIG. 4 illustrates a logic flow 400 in accordance with one or more embodiments. The logic flow 400 may be performed by various systems and/or devices and may be implemented as hardware, software, and/or any combination thereof, as desired for a given set of design parameters or performance constraints. For example, the logic flow 400 may be implemented by a logic device (e.g., processor) and/or logic (e.g., threading logic) comprising instructions, data, and/or code to be executed by a logic device. For purposes of illustration, and not limitation, the logic flow 400 is described with reference to FIG. 1. The embodiments are not limited in this context.

In various embodiments, the logic flow 400 may collect user event behavior in block 402. For example, ad optimizing service 130 or behavior event collector 232 may collect, for example, search strings entered, links followed, files downloaded, previous site visited before the current site, etc. Behavior events may be collected, for example, by examining cookie files on client 120, or otherwise examining browser history for a user accessing site application 110.

The logic flow 400 may determine whether a user behavior event matches a rule in block 404. For example, rule engine 234 may compare a collected behavior event to the rules in rules 236. Rule engine 234 may compare successive collected behavior events until a rule is matched. If a rule contains multiple conditions, requiring multiple behavior events, rule engine 234 may weight recent events more heavily than older events in considering whether a rule condition is met.

The logic flow 400 may place the user in a segment when one or more of the user's behavior events match a rule in block 406. The rule may specify in which segment to place the user. In an embodiment, a user may be placed in more than one segment at a time. In that event, all of the segments in which the user is placed may be passed to the advertising service.

The logic flow 400 may provide the segment to an ad service for targeted advertising for the segment in block 408. For example, ad optimizing service 130 may provide the segment to site application 110 to be passed to advertisement service 140. Ad optimizing service 330 may pass the segment to advertising service 340 as a return from a script call from client 320.

The segment may also be used to select which version of a web page to display to a user, for example, when a new layout is being tested. The segment may be used to target content for the user in a particular page.

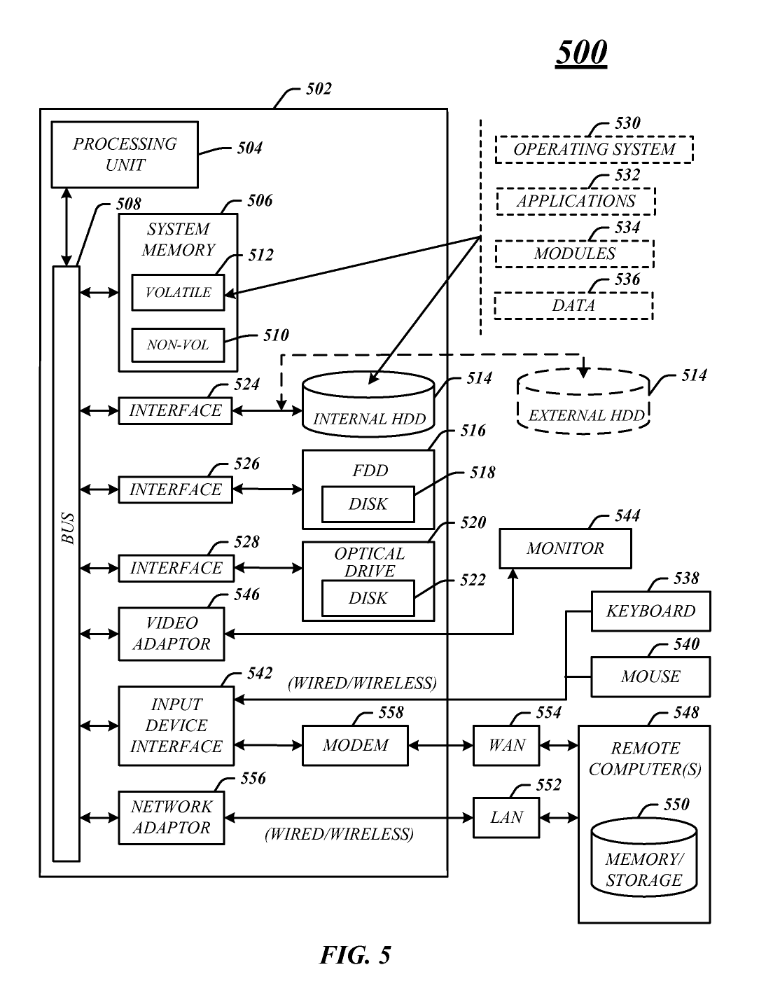

FIG. 5 illustrates a computer architecture in accordance with one or more embodiments, suitable for implementing various embodiments as previously described. The computing architecture 500 includes various common computing elements, such as one or more processors, co-processors, memory units, chipsets, controllers, peripherals, interfaces, oscillators, timing devices, video cards, audio cards, multimedia input/output (I/O) components, and so forth. The embodiments, however, are not limited to implementation by the computing architecture 500.

As shown in FIG. 5, the computing architecture 500 comprises a processing unit 504, a system memory 506 and a system bus 508. The processing unit 504 can be any of various commercially available processors. Dual microprocessors and other multi-processor architectures may also be employed as the processing unit 504. The system bus 508 provides an interface for system components including, but not limited to, the system memory 506 to the processing unit 504. The system bus 508 can be any of several types of bus structure that may further interconnect to a memory bus (with or without a memory controller), a peripheral bus, and a local bus using any of a variety of commercially available bus architectures.

The system memory 506 may include various types of memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, or any other type of media suitable for storing information. In the illustrated embodiment shown in FIG. 5, the system memory 506 can include non-volatile memory 510 and/or volatile memory 512. A basic input/output system (BIOS) can be stored in the non-volatile memory 510.

The computer 502 may include various types of computer-readable storage media, including an internal hard disk drive (HDD) 514, a magnetic floppy disk drive (FDD) 516 to read from or write to a removable magnetic disk 518, and an optical disk drive 520 to read from or write to a removable optical disk 522 (e.g., a CD-ROM or DVD). The HDD 514, FDD 516 and optical disk drive 520 can be connected to the system bus 508 by a HDD interface 524, an FDD interface 526 and an optical drive interface 528, respectively. The HDD interface 524 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and memory units 510, 512, including an operating system 530, one or more application programs 532, other program modules 534, and program data 536. The one or more application programs 532, other program modules 534, and program data 536 can include, for example, behavior event collector 232 and rule engine 234.

A user can enter commands and information into the computer 502 through one or more wire/wireless input devices, for example, a keyboard 538 and a pointing device, such as a mouse 540. Other input devices may include a microphone, an infra-red (IR) remote control, a joystick, a game pad, a stylus pen, touch screen, or the like. These and other input devices are often connected to the processing unit 504 through an input device interface 542 that is coupled to the system bus 508, but can be connected by other interfaces such as a parallel port, IEEE 1394 serial port, a game port, a USB port, an IR interface, and so forth.

A monitor 544 or other type of display device is also connected to the system bus 508 via an interface, such as a video adaptor 546. In addition to the monitor 544, a computer typically includes other peripheral output devices, such as speakers, printers, and so forth.

The computer 502 may operate in a networked environment using logical connections via wire and/or wireless communications to one or more remote computers, such as a remote computer 548. The remote computer 548 can be a workstation, a server computer, a router, a personal computer, portable computer, microprocessor-based entertainment appliance, a peer device or other common network node, and typically includes many or all of the elements described relative to the computer 502, although, for purposes of brevity, only a memory/storage device 550 is illustrated. The logical connections depicted include wire/wireless connectivity to a local area network (LAN) 552 and/or larger networks, for example, a wide area network (WAN) 554. Such LAN and WAN networking environments are commonplace in offices and companies, and facilitate enterprise-wide computer networks, such as intranets, all of which may connect to a global communications network, for example, the Internet.

When used in a LAN networking environment, the computer 502 is connected to the LAN 552 through a wire and/or wireless communication network interface or adaptor 556. The adaptor 556 can facilitate wire and/or wireless communications to the LAN 552, which may also include a wireless access point disposed thereon for communicating with the wireless functionality of the adaptor 556.

When used in a WAN networking environment, the computer 502 can include a modem 558, or is connected to a communications server on the WAN 554, or has other means for establishing communications over the WAN 554, such as by way of the Internet. The modem 558, which can be internal or external and a wire and/or wireless device, connects to the system bus 508 via the input device interface 542. In a networked environment, program modules depicted relative to the computer 502, or portions thereof, can be stored in the remote memory/storage device 550. It will be appreciated that the network connections shown are exemplary and other means of establishing a communications link between the computers can be used.

The computer 502 is operable to communicate with wire and wireless devices or entities using the IEEE 802 family of standards, such as wireless devices operatively disposed in wireless communication (e.g., IEEE 802.7 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi (or Wireless Fidelity), WiMax, and Bluetooth™ wireless technologies. Thus, the communication can be a predefined structure as with a conventional network or simply an ad hoc communication between at least two devices. Wi-Fi networks use radio technologies called IEEE 802.7x (a, b, g, etc.) to provide secure, reliable, fast wireless connectivity. A Wi-Fi network can be used to connect computers to each other, to the Internet, and to wire networks (which use IEEE 802.3-related media and functions).

Numerous specific details have been set forth to provide a thorough understanding of the embodiments. It will be understood, however, that the embodiments may be practiced without these specific details. In other instances, well-known operations, components and circuits have not been described in detail so as not to obscure the embodiments. It can be appreciated that the specific structural and functional details are representative and do not necessarily limit the scope of the embodiments.

Various embodiments may comprise one or more elements. An element may comprise any structure arranged to perform certain operations. Each element may be implemented as hardware, software, or any combination thereof, as desired for a given set of design and/or performance constraints. Although an embodiment may be described with a limited number of elements in a certain topology by way of example, the embodiment may include more or less elements in alternate topologies as desired for a given implementation.

References to “one embodiment” or “an embodiment” mean that a particular feature, structure, or characteristic described in connection with the embodiment is included in at least one embodiment. The appearances of the phrase “in one embodiment” in the specification are not necessarily all referring to the same embodiment.

Although some embodiments may be illustrated and described as comprising exemplary functional components or modules performing various operations, it can be appreciated that such components or modules may be implemented by one or more hardware components, software components, and/or combination thereof. The functional components and/or modules may be implemented, for example, by logic (e.g., instructions, data, and/or code) to be executed by a logic device (e.g., processor). Such logic may be stored internally or externally to a logic device on one or more types of computer-readable storage media.

It also is to be appreciated that the described embodiments illustrate exemplary implementations, and that the functional components and/or modules may be implemented in various other ways which are consistent with the described embodiments. Furthermore, the operations performed by such components or modules may be combined and/or separated for a given implementation and may be performed by a greater number or fewer number of components or modules.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within registers and/or memories into other data similarly represented as physical quantities within the memories, registers or other such information storage, transmission or display devices.

Some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other. With respect to software elements, for example, the term “coupled” may refer to interfaces, message interfaces, API, exchanging messages, and so forth.

Some of the figures may include a flow diagram. Although such figures may include a particular logic flow, it can be appreciated that the logic flow merely provides an exemplary implementation of the general functionality. Further, the logic flow does not necessarily have to be executed in the order presented unless otherwise indicated. In addition, the logic flow may be implemented by a hardware element, a software element executed by a processor, or any combination thereof.

While certain features of the embodiments have been illustrated as described above, many modifications, substitutions, changes and equivalents will now occur to those skilled in the art. It is therefore to be understood that the appended claims are intended to cover all such modifications and changes as fall within the true spirit of the embodiments.

1. A computer-implemented method comprising:
collecting user behavior events from a user of a browser;
determining whether a user behavior event matches a rule;
placing the user in a segment when the user behavior matches a rule; and
providing the segment to an advertising service for targeted advertising to the segment.

2. The method of claim 1, wherein collecting user behavior events comprises:
examining a cookie file generated by the browser for the user.

3. The method of claim 1, wherein collecting user behavior events comprises:
fetching user behavior events from an application program interface (API).

4. The method of claim 1, further comprising:
storing at least one of: user behavior events and a segment in a data store.

5. The method of claim 1, wherein a segment comprises a unique identifier and a name, and wherein providing the segment to the advertising service comprises providing the unique identifier.

6. The method of claim 1, wherein a rule comprises at least one condition to be met and a segment to assign when the at least one condition is met, and wherein determining whether a user behavior event matches a rule comprises:
comparing at least one user behavior event to a rule condition to determine whether the condition is met; and
placing the user in the segment to assign when the condition is met.

7. The method of claim 6, wherein a rule comprises a plurality of conditions, the method further comprising:
comparing a plurality of user behavior events to the plurality of conditions and determining that the rule is matched when all of the required conditions in the rule are met.

8. The method of claim 1, further comprising:
providing the segment to a site application to determine which of a plurality of web pages to display to the user based on the segment.

9. The method of claim 1, further comprising:
providing the segment to a site application to determine what content to display to the user based on the segment.

10. An apparatus comprising:
a processor;
a set of rules stored in a rule store;
an ad optimizing service operative on the processor, the ad optimizing service to:
determine whether a user behavior event matches a rule from the set of rules;
place the user in a segment when the user behavior matches a rule; and
provide the segment to an advertising service for targeted advertising to the segment.

11. The apparatus of claim 10, further comprising a data store, the ad optimizing service further to store the user behavior events from a user in the data store.

12. The apparatus of claim 10, the ad optimizing service further to monitor a plurality of user behavior events until at least one rule is matched.

13. The apparatus of claim 10, the ad optimizing service further to receive user behavior events from a separate data store.

14. The apparatus of claim 10, wherein the ad optimizing service comprises a representational state transfer (REST) architecture application program interface (API).

15. The apparatus of claim 14, wherein the REST API is invoked from one of a site application or a client application.

16. A machine-readable storage medium comprising instructions that when executed enable a computing system to:
receive a request for a user segment from an application;
determine whether a user behavior event matches a rule from a set of rules;
retrieve a segment from a rule when the user behavior matches the rule; and
return the segment to the requesting application.

17. The storage medium of claim 16, further comprising instructions that when executed enable the computing system to:
collect user behavior events from a user of a browser.

18. The storage medium of claim 17, wherein the instructions to collect user behavior events comprise instructions to at least one of:
examine a cookie file generated by a browser for the user; and
fetch user behavior events from an application program interface (API).

19. The storage medium of claim 16, further comprising instructions that when executed enable the computing system to:
receive user behavior events from a data store.

20. The storage medium of claim 16, wherein a rule comprises at least one condition to be met and a segment to assign when the at least one condition is met, and wherein the instructions to determine whether a user behavior event matches a rule comprise instructions to:
compare at least one user behavior event to a rule condition to determine whether the condition is met; and
place the user in the segment to assign when the condition is met.
